(19) United States
(12) Patent Application Publication
(10) Pub. No.: US 2022/0027055 A1
(43) Pub. Date: Jan. 27, 2022

(54) CONTROLLING SSD PERFORMANCE BY INTERVAL THROTTLING

(71) Applicant: SEAGATE TECHNOLOGY LLC, Fremont, CA (US)

(72) Inventors: Shuhei TANAKAMARU, San Jose, CA (US); Dana Lynn SIMONSON, Owatonna, MN (US); Erich Franz HARATSCH, Palo Alto, CA (US)

(21) Appl. No.: 16/936,321

(22) Filed: Jul. 22, 2020

(51) Int. Cl. G06F 3/06

(52) U.S. Cl. CPC G06F 3/0613; G06F 3/0653; G06F 3/0679; G06F 3/0629; G06F 3/0659

(57) ABSTRACT

Improving performance in solid state devices (SSDs) by controlling or throttling an interval between requests. In one implementation, a method includes monitoring a request queue in a solid state device (an SSD), the request queue comprising a first request and a second request having an actual time interval therebetween, and responsive to the time interval being less than a target interval, delaying acting on the second request until after the target interval.

### BACKGROUND

Solid state devices or drives (also known as SSDs) are data storage devices that use integrated circuit assemblies, and typically utilize Flash memory protocols.

Whenever there is a read request or a write request to the SSD, the SSD tries to complete the request as soon as possible. At times, the drive is very busy or may be not busy at all, depending on the incoming requests. Because of this, there are performance instabilities, such as IOPS (input/output operations per second) variations and response time variations.

### SUMMARY

This disclosure is directed to improving performance instability in solid state devices (SSDs), particularly, decreasing the instability, by controlling or throttling the SSD performance. By improving the performance, the product competitiveness improves.

This disclosure provides, in one particular implementation, a method. The method includes monitoring a request queue in a solid state device (an SSD), the request queue comprising a first request and a second request having an actual time interval therebetween, and responsive to the time interval being less than a target interval, delaying acting on the second request until after the target interval.

In another particular implementation, another method is provided. The method includes monitoring a request queue to a semiconductor storage device (an SSD), the request queue comprising a first request, a second request, and an outgoing interval between the requests, and responsive to the outgoing interval being less than a target interval, setting an actual outgoing interval to be no less than the target interval and acting on the second request after expiration of the target interval.

In another particular implementation, a system is provided. The system includes a solid state device (SSD) and a host, and an interval throttling module stored in memory and implemented by a processor, the interval throttling module located in a data request completion path of the system and comprising a queue memory unit and a delay unit, the delay unit configured to delay acting on a second request if an outgoing interval between a first request and the second request is less than a target interval.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTION OF THE DRAWING

The described technology is best understood from the following Detailed Description describing various implementations read in connection with the accompanying drawing.

FIG. 1 is a schematic diagram of an example SSD device incorporating a throttling module of this disclosure.

FIG. 2 is a schematic diagram of another example SSD device incorporating a throttling module of this disclosure.

FIG. 3 is a schematic diagram showing an example timing of incoming requests and throttled action on those requests.

FIG. 4 is an example stepwise method for throttling according to this disclosure.

FIG. 5 is a schematic diagram of another example SSD device incorporating a throttling module of this disclosure.

FIG. 6 is another example stepwise method for throttling according to this disclosure.

### DETAILED DESCRIPTION

When there is a read request or a write request to the SSD, the SSD tries to complete the request as soon as possible. At times, the drive is very busy or not busy at all, depending on the incoming requests. The present disclosure provides a methodology to improve the SSD performance by spacing out (e.g., throttling) the requests in the queue to be acted on.

In general, a throttling module of this disclosure has two sub-units, a delay unit and a throttle queue. The delay unit receives a read or write request, transfers the request to the throttle queue, which sends it to be acted on no sooner than after a predefined interval (T_TargetInterval). The target performance of the system (i.e., IOPS) is the inverse of the T_TargetInterval.

The throttling module can be placed anywhere in the data path of the SSD unit, in either the read path or the write path, or both.

By setting a minimum time between acting on requests, i.e., the T_TargetInterval, the IOPS can be precisely controlled, resulting in decreased performance variations and significantly improved overall SSD performance.

It is noted that throttling does not improve overall performance in the sense of increased speed, but rather, throttling makes the performance more consistent, which is especially desirable in large network (e.g., “Cloud”) environments where a service level agreement often requires specific response times. While this could be termed “performance,” the general use of the term more often refers to simple throughput.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

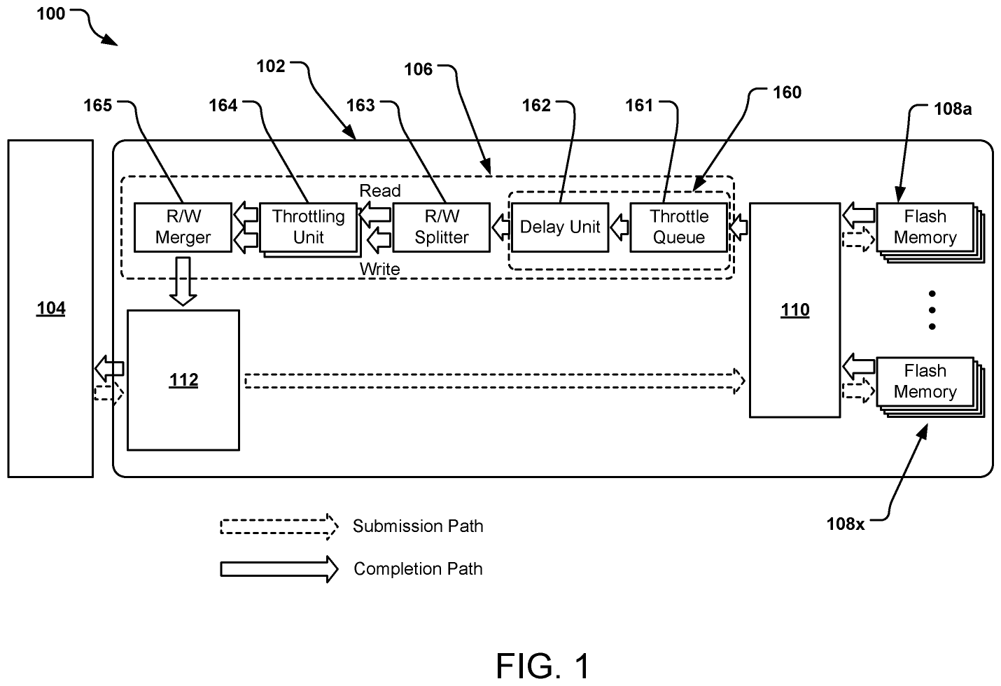

FIG. 1 illustrates a system 100 including a solid state drive (SSD) 102 and a host 104, the system 100 including a throttling module 106 incorporated therein, in this particular implementation, in the SSD 102. The SSD 102 has at least one Flash memory 108, here shown as a first memory 108a and another memory 108x. In other implementations, the memory 108 may be PCRAM (phase-change RAM), MRAM (magnetoresistive RAM), STTRAM (spin-transfer torque RAM), FeRAM (ferroelectric RAM), or ReRAM (resistive RAM). The SSD 102 also includes a back-end controller 110 and a front-end controller 112. In some implementations, one hardware element, or controller, provides the functions of both the back-end controller 110 and the front-end controller 112.

Within the SSD 102 and between the host 104 and the SSD 102 are various data paths, particularly, read/write submission paths shown as dotted arrows and various completion paths shown as solid arrows. Within the SSD 102, the submission and completion paths run between the memories 108, the back-end controller 110 and the front-end controller 112. The submission and completion paths also run within each element (e.g., the host 104, the back-end controller 110 and the front-end controller 112). In the particular system 100 of FIG. 1, the throttling module 106 is positioned between the back-end controller 110 and the front-end controller 112, in the completion path of the read and write requests.

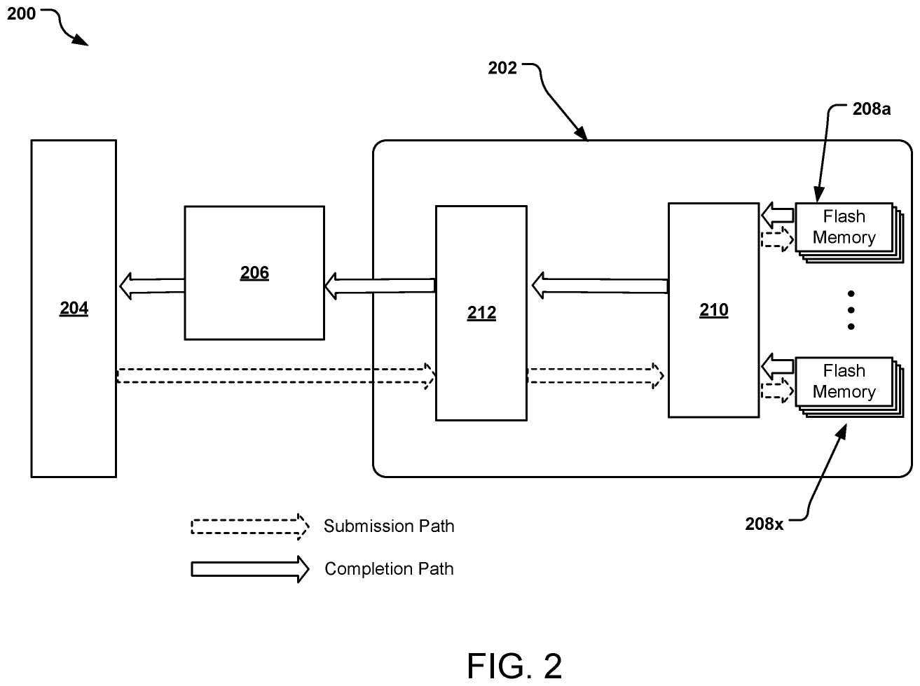

In an alternate system 200 shown in FIG. 2, the throttling module is positioned outside of the SSD, between the SSD and the host in a completion path. Particularly, the system 200 has an SSD 202 and a host 204, with a throttling module 206 positioned between the SSD 202 and the host 204. As in the system 100, the SSD 202 has at least one Flash memory 208, a back-end controller 210 and a front-end controller 212, with appropriate submission paths and completion paths between the various components.

The throttling module can be positioned in any location within the system 100 or system 200, within a data path. Although the completion path is desired, the throttling module could be present in a submission path. As another example, the throttling module can be positioned between Flash memory and the back-end controller.

Returning to FIG. 1, the throttling module 106 includes several sub-modules, including a throttling unit 160 that has a throttle queue unit 161 and a delay unit 162; the queue unit 161 may be, e.g., a volatile memory for storing the request queue. The throttling module 106 also may include a read/write splitter 163, a throttling unit 164 having a first portion for the read actions and a second portion for the write actions, and a read/write merger 165.

In the system 100 and the system 200, the throttling module 106, 206, respectively, is configured to control the interval between all read and write requests. In alternate implementations, the read requests and write requests are throttled independently.

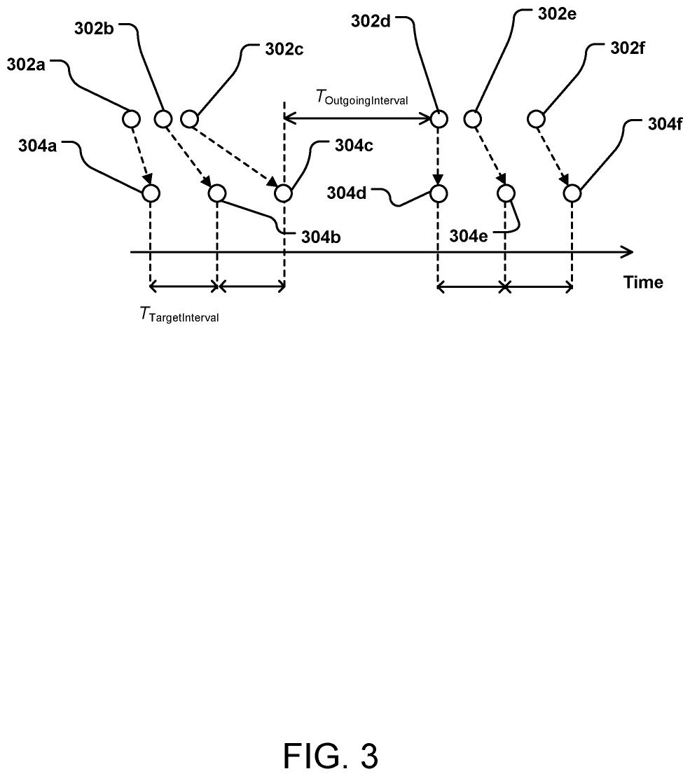

FIG. 3 shows an example of spacing out (e.g., throttling) the requests in the queue by delaying acting on the requests, if needed, to obtain a minimum interval (T_TargetInterval) between outgoing requests. These requests may be only read requests, only write requests, or both read and write requests.

A plurality of requests 302, either read requests or write requests, or both, are shown in FIG. 3 as a queue of requests 302a, 302b, 302c, 302d, 302e, 302f that arrive in variable intervals, to be acted on, shown as T_OutgoingInterval. T_OutgoingInterval, as used herein, is either (1) the elapsed time between the time the last outgoing request was completed and the current time t if the current request is not completed yet, or (2) the actual time interval between two consecutive outgoing requests once both of them are actually completed. The delay unit of the throttling module (e.g., the delay unit 162 of the throttling module 106) rectifies the timing of the queue of the requests 302 (e.g., the queue unit 161) to the desired interval, T_TargetInterval, as outgoing requests 304. The value for T_TargetInterval may be between, e.g., 1 microsecond and 100 microseconds. The particular T_TargetInterval depends on the SSD and the desired IOPS; the expected IOPS is the inverse of the T_TargetInterval.

The T_TargetInterval may be a fixed interval, e.g., set by the drive controller or by the user, or the T_TargetInterval may initially be fixed and then dynamically adjusted. For example, the T_TargetInterval can be based on an average of the real interval, e.g., arithmetic means, moving average, exponential moving average, etc. Any average calculation can be, e.g., an arithmetic mean, a moving average, an exponential moving average, based on the real interval of requests, e.g., T_IncomingInterval, which can be greater than the T_TargetInterval, less than the T_TargetInterval, or the same as the T_TargetInterval.

Because incoming request 302a is the first sent, the corresponding outgoing request 304a is acted on without delay, essentially immediately. The second incoming request 302b occurs at an actual T_IncomingInterval where the corresponding T_OutgoingInterval will be less than the desired interval T_TargetInterval if this request is acted on immediately upon receipt; thus, the corresponding outgoing request 304b is delayed so that the interval between request 304a and 304b (i.e., T_OutgoingInterval) is T_TargetInterval. Similarly, the third incoming request 302c occurs at an actual T_IncomingInterval where the corresponding T_OutgoingInterval will be less than the desired interval T_TargetInterval if this request is acted on immediately upon receipt; thus, the corresponding outgoing request 304c is delayed so that the interval between request 304b and 304c (i.e., T_OutgoingInterval) is T_TargetInterval. The fourth incoming request 302d has an actual T_OutgoingInterval that is at least, and even more than, the desired interval T_TargetInterval if this request is acted on immediately up receipt; thus, the corresponding outgoing request 304d is completed essentially immediately with no delay. The fifth incoming request 302e occurs at an actual T_IncomingInterval after the fourth request 302d where the corresponding T_OutgoingInterval will be less than the desired interval T_TargetInterval if this request is acted on immediately upon receipt; thus, the corresponding outgoing request 304d is delayed so that the interval between the request 304c and 304d (i.e., T_OutgoingInterval) is T_TargetInterval. The sixth incoming request 302f occurs at an actual T_IncomingInterval after the fifth incoming request 302e that is approximately the same as the desired interval T_TargetInterval; however, because of the delay in acting on the fifth request (i.e., the outgoing request 304e), the corresponding outgoing request 304f is also delayed so that the interval between the outgoing request 304e and the outgoing request 304f is T_TargetInterval.

Summarized, the interval between outgoing requests 304 (T_OutgoingInterval) is no less than T_TargetInterval, or, the interval between outgoing requests 304 (T_OutgoingInterval) is T_TargetInterval or greater.

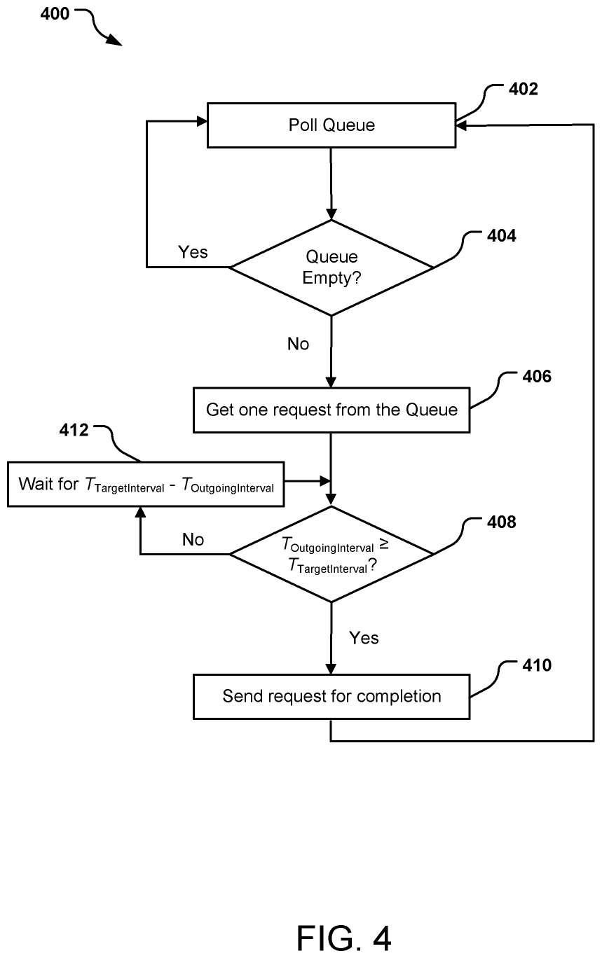

An overall example methodology of the delay unit (e.g., the delay unit 162) to throttle the requests is shown in FIG. 4 as method 400. In a first step 402, the throttle queue is evaluated, or polled. If the queue is evaluated as empty, in step 404, then the method repeats, returning to the first step 402. If the queue is not empty, the delay unit accepts one request (either a read or write request) from the queue in step 406. The timing of receipt of the request is compared to the time of the previous request in step 408; if the actual interval between the requests (T_OutgoingInterval) is greater than or equal to the target interval (T_TargetInterval), then the request is sent for completion in step 410. If the T_OutgoingInterval is less than the T_TargetInterval, then there is a delay, in step 412, for a duration equal to T_TargetInterval less T_OutgoingInterval. Once the T_TargetInterval time has elapsed (step 408), the request is sent for completion in step 410.

In the previous discussion, the throttling of the requests is based on the interval between outgoing requests being no less than T_TargetInterval, or, the interval between outgoing requests being T_TargetInterval or greater. In some implementations, an additional consideration is incorporated into the throttling methodology.

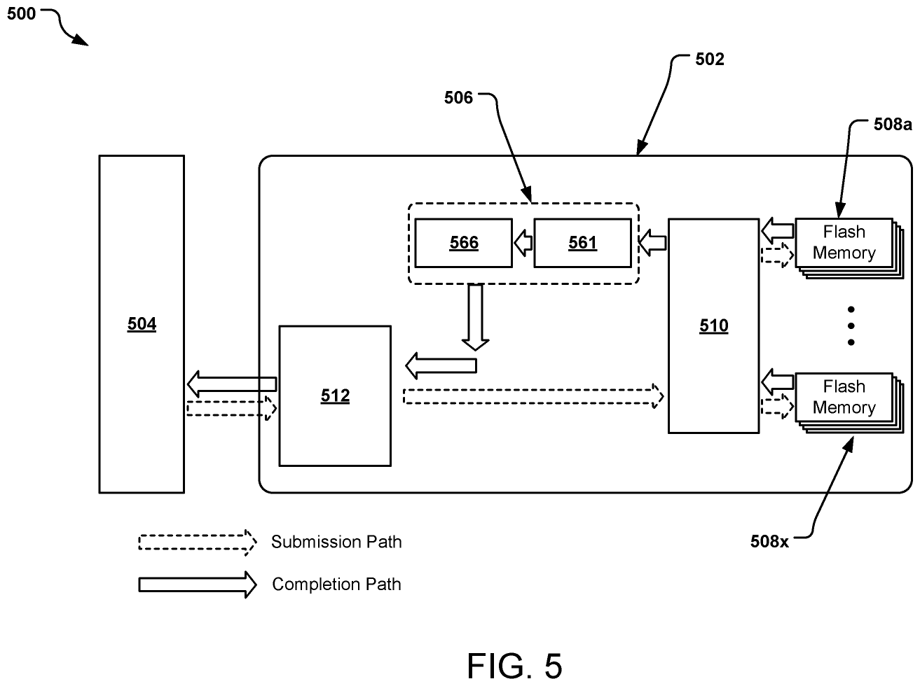

FIG. 5 illustrates another implementation of a throttling module in a system 500, in this system 500, the throttling module factors in the bandwidth, by calculating and updating the average data transfer length when a request is received. Incoming requests can vary significantly in their transfer length; based on the average transfer length, the T_TargetInterval can be adjusted.

The system 500 includes a solid state drive (SSD) 502 and a host 504, with a throttling module 506 incorporated in the system 500, in this particular implementation, in the SSD 502. The SSD 502 has at least one Flash memory 508, here shown as a first memory 508a and another memory 508x. The SSD 502 also includes a back-end controller 510 and a front-end controller 512.

Within the SSD 502 and between the host 504 and the SSD 502 are various data paths, particularly, read/write submission paths shown as dotted arrows and various completion paths shown as solid arrows. The submission and completion paths run between the memories 508, the back-end controller 510 and the front-end controller 512. The submission and completion paths also run within each element (e.g., the host 504, the back-end controller 510 and the front-end controller 512).

In the system 500, the throttling module 506 is positioned between the back-end controller 510 and the front-end controller 512, in the completion path of the read and write requests. In alternate systems, the throttling module is positioned outside of the SSD 502, or elsewhere in the SSD 502, e.g., between Flash memory 508 and the back-end controller 510.

The throttling module 506 includes several sub-modules, including a throttle queue unit 561 (e.g., a volatile memory for storing the request queue) and a bandwidth throttle unit 566. The throttling module 506 also may include, although not shown in FIG. 5, a delay unit, a read/write splitter, a throttling unit, and a read/write merger. The throttling module 506 can control the interval between requests, either all read and write requests, or the read requests and write requests independently.

The bandwidth throttle unit 566 calculates the interval T_TargetInterval by deriving the average transfer length X_ave, where the transfer length is the size of the request, e.g., 4 KB, 60 KB, etc. The average transfer length X_ave can be any type of average, e.g., arithmetic means, moving average, exponential moving average, etc. Updating of the T_TargetInterval can occur, e.g., after every request, after every “N” requests (e.g., after 10 requests, after 100 requests), after a time period (T_update) (e.g., every 1 second, every 10 seconds).

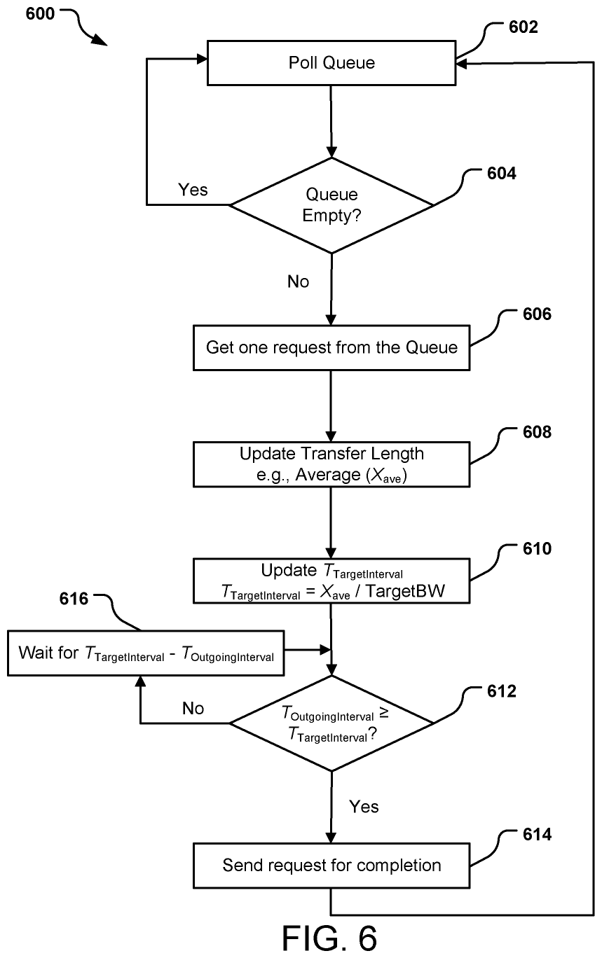

An overall example methodology of the throttling module with a bandwidth throttle unit is shown in FIG. 6 as method 600, utilizing an update of the average transfer length (X_ave) after each request. In a first step 602, the throttle queue is evaluated, or polled. The queue is evaluated as empty, in step 604, then the method repeats thus far, returning to the first step 602. If the queue is not empty, the delay unit accepts one request (either a read or write request) from the queue in step 606. In step 608, the average transfer length (X_ave) is updated. In step 610, the T_TargetInterval is updated, so that T_TargetInterval is the X_ave divided by the target bandwidth, which is provided by the controller. In some implementations, the target bandwidth may be set by the user. The target bandwidth may be constant or may be dynamically adjusted, e.g., by the system or by a user. In step 612, the time of receipt of the request is compared to the time of the previous request; if the actual interval between the requests (T_OutgoingInterval) is greater than or equal to the updated target interval (T_TargetInterval), then the request is sent for completion in step 614. If the T_OutgoingInterval is less than the updated T_TargetInterval, then there is a delay, in step 616, for a duration equal to T_TargetInterval less T_OutgoingInterval. Once the T_TargetInterval time has elapsed (step 612), the request is sent for completion in step 614.

Summarized, the interval between requested being acted on is T_TargetInterval or greater, where T_TargetInterval is periodically updated based on the average transfer length (X_ave) and the target bandwidth.

The throttling modules described herein may be implemented as and/or processed as software or other machine-readable instructions. When implemented as processes in software, the modules may be provided as executable code which, when run on a device having a processor and computer capability, implement a process or method as described. The modules or code may be stored on a computer device or may be stored on a memory and may be connected to or downloaded to a computer device. In alternate implementations, the throttling modules may be implemented in hardware.

In summary, described herein are methodologies for improving the performance of an SSD by throttling the incoming requests by having a minimum time interval between actions. The throttling is accomplished by a throttling module stored in memory of an SSD and implemented by a processor. The throttling module can be configured to throttle read requests, write requests, or both read and write requests.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the disclosure or the recited claims.

1. A method comprising:
monitoring a request queue in a solid state device (an SSD), the request queue comprising a first request and a second request having an actual time interval therebetween, each of the first request and the second request having a data transfer length;
determining the data transfer length of at least one of the first request and the second request;
determining a target interval as the data transfer length divided by a target bandwidth value; and
responsive to the actual time interval being less than the target interval, delaying acting on the second request until after the target interval.

2. The method of claim 1, wherein the target interval is fixed.

3. (canceled)

4. (canceled)

5. (canceled)

6. The method of claim 1 further comprising:
determining an average data transfer length of the first request and the second request; and
updating the target interval to be the average data transfer length divided by the target bandwidth value.

7. The method of claim 1, wherein the target bandwidth value is fixed.

8. The method of claim 1, wherein the target bandwidth value is dynamically adjusted.

9. A method comprising:
monitoring a request queue to a semiconductor storage device (an SSD), the request queue comprising a first request having a length, a second request having a length, and an outgoing interval between the first and second requests;
determining the length of at least one of the first request and the second request;
determining a target interval as the length dividing by a target bandwidth value; and
responsive to the outgoing interval being less than the target interval, setting an actual outgoing interval to be no less than the target interval and acting on the second request after expiration of the target interval.

10. The method of claim 9, wherein the target interval is fixed.

11. (canceled)

12. (canceled)

13. (canceled)

14. The method of claim 9 further comprising:
determining an average length of the first and second requests; and
updating the target interval to be the average length divided by the target bandwidth value.

14. (canceled)

15. The method of claim 13, wherein the target bandwidth value is dynamically adjusted.

16. A system comprising:
a solid state device (SSD) and a host; and
an interval throttling module stored in a memory and implemented by a processor, the interval throttling module located in a data request completion path of the system and comprising a queue memory unit and a delay unit, the delay unit configured to delay acting on a second request if an outgoing interval between a first request and the second request is less than a target interval, where the target interval is a data transfer length of at least one of the first request and the second request divided by a target bandwidth value is.

17. The system of claim 16, wherein the interval throttling module is located in the SSD.

18. The system of claim 17, wherein the interval throttling module is located between a back-end controller and a front-end controller.

19. The system of claim 17, wherein the interval throttling module is located between a back-end controller and a Flash memory.

20. The system of claim 16, wherein the interval throttling module is located between the SSD and the host.
